(19) United States
(12) Patent Application Publication
(10) Pub. No.: US 2014/0170991 A1
(43) Pub. Date: Jun. 19, 2014

(54) AGILE ACTIVE INTERFERENCE CANCELLATION (AAIC) FOR MULTI-RADIO MOBILE DEVICES

(71) Applicant: QUALCOMM INCORPORATED, San Diego (CA)

(72) Inventors: Bongyong SONG, San Diego, CA (US); Samir Salib SOLIMAN, Poway, CA (US); Cong T. NGUYEN, San Diego, CA (US)

(73) Assignee: QUALCOMM Incorporated, San Diego, CA (US)

(21) Appl. No.: 13/718,377

(22) Filed: Dec. 18, 2012

(51) Int. Cl. H04B 1/38

(52) U.S. Cl. CPC H04B 1/38
USPC 455/73

(57) ABSTRACT

A method of performing interference cancellation in a communication device having a plurality of transceivers includes: detecting a co-existence issue between a first transceiver and a second transceiver of the plurality of transceivers; determining parameters of the co-existence issue; selecting the first transceiver for providing an input signal to an interference cancellation (IC) circuit; selecting the second transceiver for receiving an output signal from the IC circuit; configuring the IC circuit based on the parameters of the co-existence issue; and generating the output signal based on the input signal and the parameters to reduce interference caused by the first transceiver on the second transceiver.

### BACKGROUND

1. Field

The disclosure relates generally to the field of interference cancellation systems and methods, and, in particular, to systems and methods for cancelling interference produced by multiple radios operating on the same, adjacent, harmonic/sub-harmonic, or intermodulation product frequencies.

2. Background

Many mobile and non-mobile electronic devices include multiple communication devices that communicate using different protocols having overlapping or nearby frequency channels. For example, certain mobile devices include both a wireless local area network (“WLAN”) transceiver operating at a frequency between 2.4 GHz and 2.5 GHz and a Bluetooth transceiver operating at a frequency between 2.4 GHz and 2.5 GHz that may lead to co-existence issues due to the proximity of their frequencies. In another example, a WLAN transceiver operating at a frequency between 2.4 GHz and 2.5 GHz can interfere with a wireless wide area network (WWAN) transceiver using LTE band 7 that utilizes 2.5 GHz through 2.57 GHz for uplink and 2.62 GHz through 2.69 GHz for downlink.

Existing solutions attempt to solve this problem by avoiding interference (e.g., in time, frequency and power domains). Moreover, existing solutions are generally specific to one particular co-existence combination (e.g., only for the combination of Bluetooth and WLAN) requiring a different solution for each co-existence issue.

### SUMMARY

A method of performing interference cancellation in a communication device having a plurality of transceivers includes, but is not limited to any one or combination of: detecting a co-existence issue between a first transceiver and a second transceiver of the plurality of transceivers; determining parameters of the co-existence issue; selecting the first transceiver for providing an input signal to an interference cancellation (IC) circuit; selecting the second transceiver for receiving an output signal from the IC circuit; configuring the IC circuit based on the parameters of the co-existence issue; and generating the output signal based on the input signal and the parameters to reduce interference caused by the first transceiver on the second transceiver.

In various embodiments, the first transceiver comprises a transmitter and the second transceiver comprises a receiver.

In various embodiments, the generating includes applying the output signal to a signal received by the second transceiver.

In various embodiments, the output signal is generated by the IC circuit.

In various embodiments, the parameters of the co-existence issue include at least a coupling channel gain, a frequency, and a delay of signal transmitted by the first transceiver.

In various embodiments, the first transceiver and the second transceiver are selected based on the co-existence issue between the first transceiver and the second transceiver.

In various embodiments, the method further includes: detecting a second co-existence issue between the first transceiver and a third transceiver of the plurality of transceivers; determining parameters of the second co-existence issue; selecting the first transceiver for providing the input signal to the IC circuit; selecting the third transceiver for receiving the output signal from the IC circuit; configuring the IC circuit based on the parameters of the second co-existence issue; and generating the output signal based on the input signal and the parameters of the second co-existence issue to reduce interference caused by the first transceiver on the third transceiver.

In various embodiments, the method further includes: detecting a second co-existence issue between a third transceiver and a fourth transceiver of the plurality of transceivers; determining parameters of the second co-existence issue; selecting the third transceiver for providing the input signal to the IC circuit; selecting the fourth transceiver for receiving the output signal from the IC circuit; configuring the IC circuit based on the parameters of the second co-existence issue; and generating the output signal based on the input signal and the parameters of the second co-existence issue to reduce interference caused by the third transceiver on the fourth transceiver.

In various embodiments, the first transceiver transmits signals on a frequency within a first frequency band. The second transceiver receives signals at frequency within a second frequency band. The first frequency band at least partially overlaps the second frequency band.

In various embodiments, the first transceiver transmits signals on a frequency within a first frequency band. The second transceiver receives signals at frequency within a second frequency band. The first frequency band is adjacent the second frequency band.

In various embodiments, the first transceiver transmits signals on a frequency within a first frequency band. The second transceiver receives signals at frequency within a second frequency band. The first frequency band includes a sub-harmonic frequency of the second frequency band.

In various embodiments, the first transceiver transmits signals on a frequency within a first frequency band. The second transceiver receives signals at frequency within a second frequency band. The first frequency band includes a harmonic frequency of the second frequency band.

In various embodiments, the first transceiver transmits signals on a frequency within a first frequency band. The second transceiver receives signals at frequency within a second frequency band. A third transceiver transmits signals at frequency within a third frequency band. An intermodulation product frequency band of the first and third frequency bands at least partially overlaps the second frequency band.

In various embodiments, the detecting includes accessing a database of known transceiver combinations that cause co-existence issues. The database includes a combination between the first transceiver and the second transceiver.

In various embodiments, the method further includes detecting an intensity of the interference caused by the first transceiver on the second transceiver. The co-existence issue is not detected if the intensity is below a predetermined threshold.

In various embodiments, the IC circuit includes a multi-tap least mean square (LMS) filter.

In some embodiments, the LMS filter comprises a three-tap LMS filter.

In some embodiments, the LMS filter comprises a single-tap LMS filter.

In various embodiments, at least one transceiver of the plurality of transceivers is configured to receive navigation signals.

An apparatus for reducing interference in a communication device having a plurality of transceivers includes an interference cancellation (IC) circuit and a processor coupled to the IC circuit. The processor is configured for, but is not limited to any one or combination of: detecting a co-existence issue between a first transceiver and a second transceiver of the plurality of transceivers; determining parameters of the co-existence issue; selecting the first transceiver for providing an input signal to the IC circuit; selecting the second transceiver for receiving an output signal from the IC circuit; configuring the IC circuit based on the parameters of the co-existence issue. The IC circuit is configured to generate the output signal based on the input signal and the parameters to reduce interference caused by the first transceiver on the second transceiver.

An apparatus for reducing interference in a communication device having a plurality of transceivers includes, but is not limited to any one or combination of: means for detecting a co-existence issue between a first transceiver and a second transceiver of the plurality of transceivers; means for determining parameters of the co-existence issue; means for selecting the first transceiver for providing an input signal to an interference cancellation (IC) circuit; means for selecting the second transceiver for receiving an output signal from the IC circuit; means for configuring the IC circuit based on the parameters of the co-existence issue; and means for generating the output signal based on the input signal and the parameters to reduce interference caused by the first transceiver on the second transceiver.

A computer program product for reducing interference in a communication device having a plurality of transceivers includes a computer-readable storage medium comprising code for, but is not limited to any one or combination of: detecting a co-existence issue between a first transceiver and a second transceiver of the plurality of transceivers; determining parameters of the co-existence issue; selecting the first transceiver for providing an input signal to an interference cancellation (IC) circuit; selecting the second transceiver for receiving an output signal from the IC circuit; configuring the IC circuit based on the parameters of the co-existence issue; and generating the output signal based on the input signal and the parameters to reduce interference caused by the first transceiver on the second transceiver.

### BRIEF DESCRIPTION OF THE DRAWINGS

FIG. 1 is a block diagram illustrating an environment that includes a device according to various embodiments of the disclosure.

FIG. 2 is a block diagram of an illustrative hardware configuration for an apparatus employing a processing system according to various embodiments of the disclosure.

FIG. 3 is a portion of a hardware configuration according to various embodiments of the disclosure.

FIG. 4 is a diagram of a communication system according to various embodiments of the disclosure.

FIGS. 5A-5B are flow charts of a method according to various embodiments of the disclosure.

FIG. 6 is an illustrative portion of a communication system according to various embodiments of the disclosure.

### DETAILED DESCRIPTION

Various embodiments relate to methods and systems for cancelling interference produced by multiple radios (transceivers) operating on the same, adjacent, harmonic/sub-harmonic frequencies, or intermodulation product frequencies. In particular embodiments, an interference-cancellation system is adaptable for different radio combinations. For instance, for a co-existence issue caused by a first combination of radios, the transmitting radio (e.g., WiFi) may be selected for an input of an interference cancellation (IC) circuit and the receiving radio (e.g., Bluetooth) may be selected for the output of the IC circuit. For a co-existence issue caused by a second (different) combination of radios, the transmitting radio (e.g., WiFi) may be selected for the input of the IC circuit and the receiving radio (e.g., LTE band 7) may be selected for the output of the IC circuit. It should be noted that the terms cancellation (as in interference cancellation) and variants thereof may be synonymous with reduction, mitigation, and/or the like in that at least some interference is reduced.

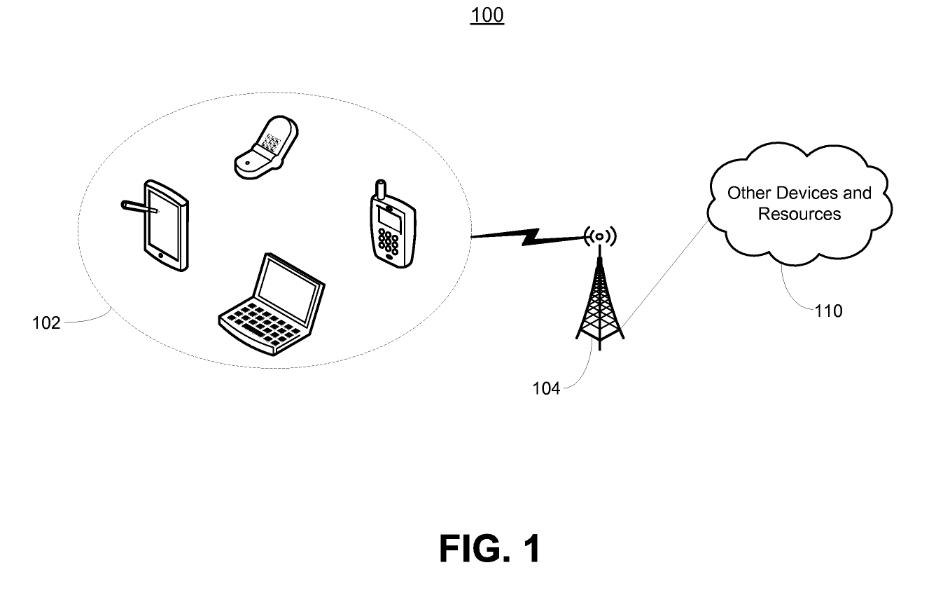

FIG. 1 is a block diagram illustrating an environment 100 that includes a device 102. The environment 100 may be representative of any system(s) or a portion thereof that may include at least one device 102 enabled to transmit and/or receive wireless signals to/from at least one wireless system 104. The device 102 may, for example, include a mobile device or a device that while movable is primarily intended to remain stationary. The device 102 may also include stationary devices (e.g., desktop computer) enabled to transmit and/or receive wireless signals. Thus, as used herein, the terms “device” and “mobile device” may be used interchangeably as each term is intended to refer to any single device or any combinable group of devices that may transmit and/or receive wireless signals.

In various embodiments, the device 102 may include a mobile device such as a cellular phone, a smart phone, a personal digital assistant, a portable computing device, a navigation device, a tablet, and/or the like or any combination thereof. In other embodiments, the device 102 may take the form of a machine that is mobile or stationary. In yet other embodiments, the device 102 may take the form of one or more integrated circuits, circuit boards, and/or the like that may be operatively enabled for use in another device.

The device 102 may include at least one radio (also referred to as a transceiver). The terms “radio” or “transceiver” as used herein refers to any circuitry and/or the like that may be enabled to receive wireless signals and/or transmit wireless signals. In particular embodiments, two or more radios may be enabled to share a portion of circuitry and/or the like (e.g., a processing unit, memory, etc.). That is the terms “radio” or “transceiver” may be interpreted to include devices that have the capability to both transmit and receive signals, including devices having separate transmitters and receivers, devices having combined circuitry for transmitting and receiving signals, and/or the like.

In some embodiments, the device 102 may include a first radio enabled to receive and/or transmit wireless signals associated with at least a first network of a wireless system 104 and a second radio that is enabled to receive and/or transmit wireless signals associated with at least a second network of the wireless system 104 and/or at least one navigation system 106 (e.g., a satellite positioning system and/or the like).

The wireless system 104 may, for example, be representative of any wireless communication system or network that may be enabled to receive and/or transmit wireless signals. By way of example but not limitation, the wireless system 104 may include one or more of a wireless wide area network (WWAN), a wireless local area network (WLAN), a wireless personal area network (WPAN), a wireless metropolitan area network (WMAN), a Bluetooth communication system, WiFi communication system, Global System for Mobile communication (GSM) system, Evolution Data Only/Evolution Data Optimized (EVDO) communication system, Ultra Mobile Broadband (UMB) communication system, Long Term Evolution (LTE) communication system, Mobile Satellite Service-Ancillary Terrestrial Component (MSS-ATC) communication system, and/or the like.

The wireless system 104 may be enabled to communicate with and/or otherwise operatively access other devices and/or resources as represented simply by cloud 110. For example, the cloud 110 may include one or more communication devices, systems, networks, or services, and/or one or more computing devices, systems, networks, or services, and/or the like or any combination thereof.

The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and/or the like. A CDMA network may implement one or more radio access technologies (RATs) such as cdma2000, Wideband CDMA (W-CDMA), to name just a few radio technologies. Here, cdma2000 may include technologies implemented according to IS-95, IS-2000, and IS-S56 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include (but not limited to) a Bluetooth network, an IEEE 802.15x, for example.

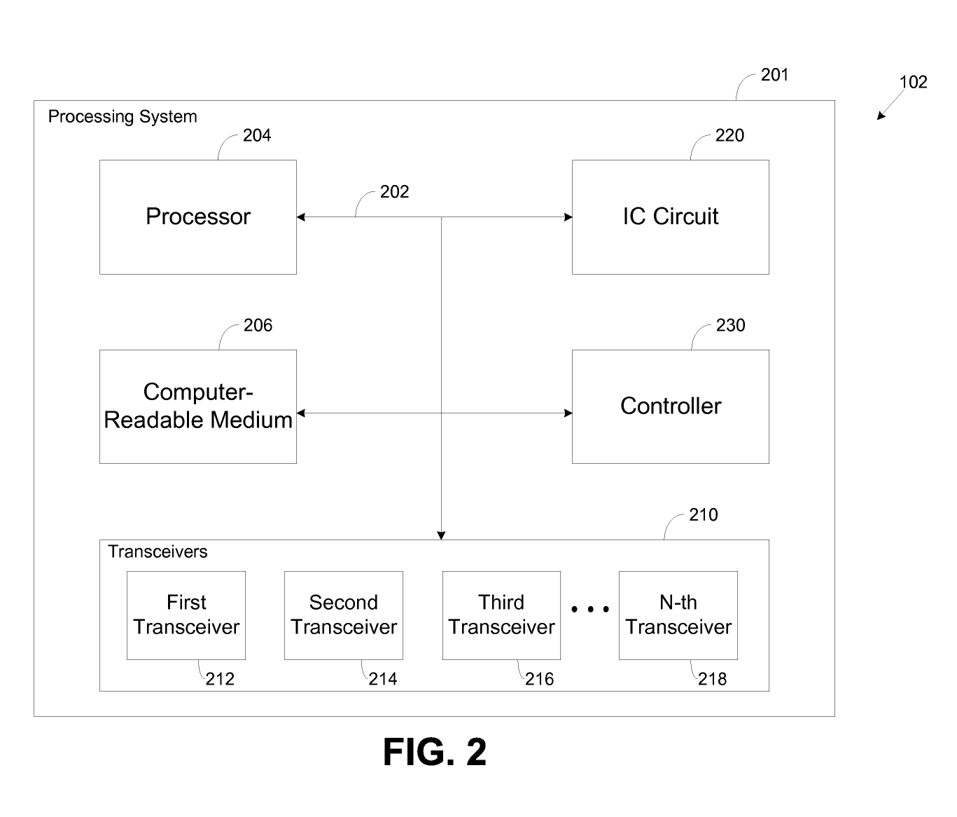

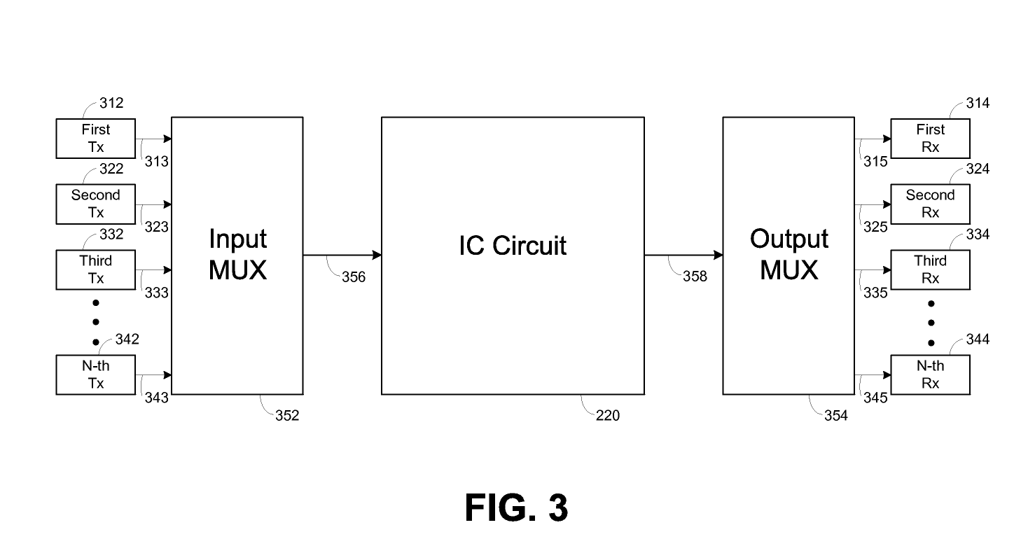

FIG. 2 is a block diagram of an illustrative hardware configuration for an apparatus, such as the device 102, employing a processing system 201 according to various embodiments of the disclosure, including (but not limited to) the embodiments of FIGS. 1 and 3-6. In this example, the processing system 201 may be implemented with a bus architecture represented generally by bus 202. The bus 202 may include any number of interconnecting buses and bridges depending on the specific application of the processing system 201 and the overall design constraints. The bus 202 links together various circuits including one or more processors, represented generally by the processor 204, and computer-readable media, represented generally by the computer-readable medium 206. The bus 202 may also link various other circuits such as timing sources, peripherals, voltage regulators, and power management circuits, which are well known in the art, and therefore, will not be described any further. A bus interface 208 provides an interface between the bus 202 and a plurality of transceivers 210. Each of the transceivers 210 allows for communicating with various other apparatus over a transmission medium.

A processor 204 is responsible for managing the bus 202 and general processing, including the execution of software stored on computer-readable storage medium 206. The software, when executed by the processor 204, causes the processing system 201 to perform the various functions described in the disclosure for any particular apparatus. The computer readable storage medium 206 may also be used for storing data that is manipulated by the processor 204 when executing software.

In various embodiments, the processing system 201 includes an interference cancellation (IC) circuit 220 and a controller 230. The IC circuit 220 is configured to cancel interference produced by the transceivers 210 that are operating on the same, adjacent, or harmonic/sub-harmonic frequencies. The controller 230 may be as a microcontroller, a microprocessor, computer, state machine, or other programmable device. The controller 230 is coupled to the IC circuit 220. The controller 230 executes one or more algorithms and/or include control logic (e.g., as stored on the computer-readable storage medium 206) for optimizing the reduction of interference by the IC circuit 220. In particular, the controller 230 adjusts the settings of the IC circuit 220 to adjust the amplitude, phase, and/or delay of an input signal to generate an output. In some embodiments, the controller may be the processor 204.

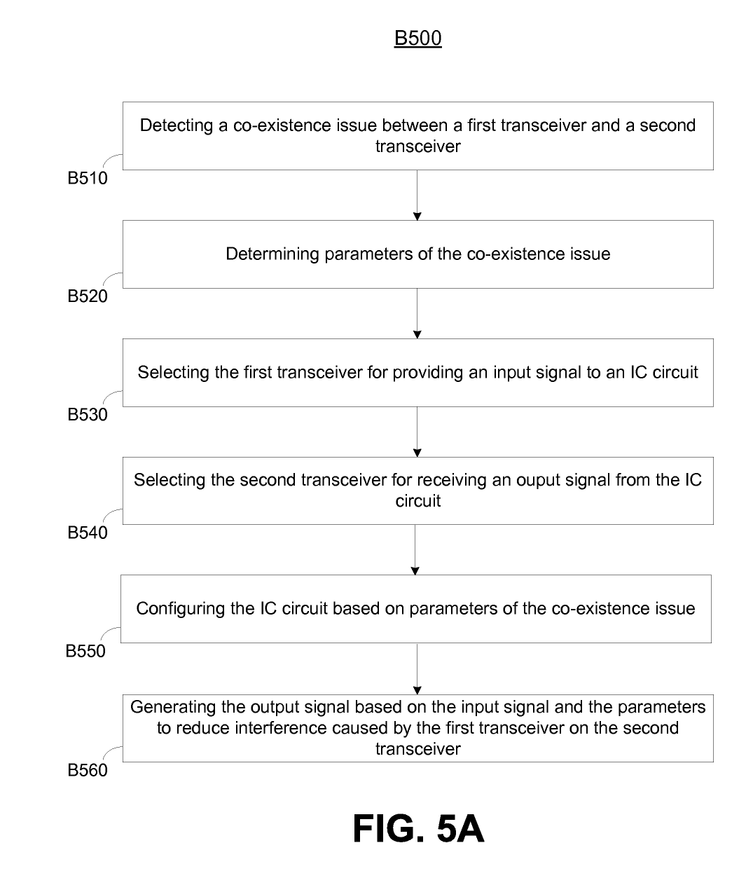

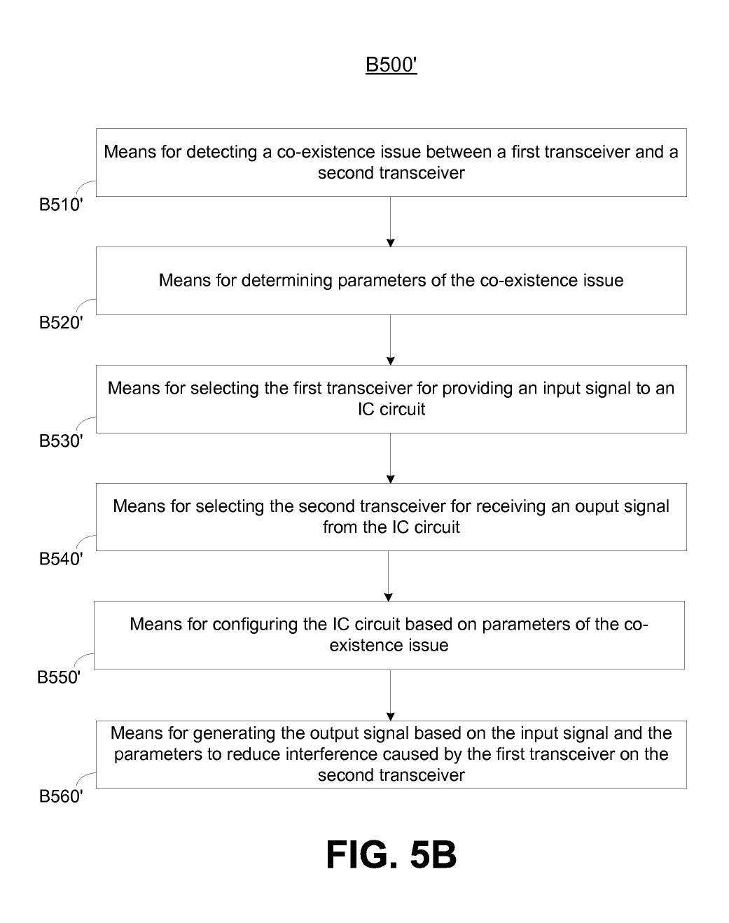

FIG. 5A illustrates a method B500 of interference management, for example for reduction or cancellation of such interference, according to various embodiments of the disclosure. With reference to FIGS. 1-3 and 5A, the method B500 may be performed, for example, by the processing system 201 (e.g., the IC circuit 220, the controller 230, etc.).

In various embodiments, the plurality of transceivers 210 may include n transceivers (e.g., two transceivers, three transceivers, etc.), such as, for example (but not limited to), a first transceiver 212, a second transceiver 214, a third transceiver 216, to an n-th transceiver 218. The first transceiver 212 may include a first transmitter 312 and a first receiver 314. The second transceiver 214 may include a second transmitter 322 and a second receiver 324. The third transceiver 216 may include a third transmitter 332 and a third receiver 334. The n-th transceiver 218 may include an n-th transmitter 342 and an n-th receiver 344. Depending on which transmitters are active (e.g., transmitting) and which receivers are active (e.g., receiving), any number of co-existence issues may occur.

Each of the transceivers 210 may operate according to various parameters, such as a respective frequency, radio frequency circuits with group delays, coupling channel gains to other transceivers, and/or the like. For instance, the first transceiver 212 may operate at a first frequency f1 with a first delay d1, the second transceiver 214 may operate at a second frequency f2 with a second delay d2, the third transceiver 216 may operate at a third frequency f3 with a third delay d3, and the n-th transceiver 218 may operate at an n-th frequency fn with an n-th delay d2. The first transceiver 212 may have a coupling channel gain h12 to the second transceiver 214, a coupling channel gain h13 to the third transceiver 216, and a coupling channel gain h1n to the n-th transceiver 218, respectively. Other transceivers 210 may have different coupling channel gains to various transceivers 210.

In various embodiments, the processing system 201 is configured to reduce interference produced among transceivers of the plurality of transceivers 210 operating on the same, adjacent, harmonic, or sub-harmonic frequencies. In particular embodiments, the processing system 201 is configured to be adaptable for different transceiver combinations. That is, the processing system 201 is configured to cancel interference based on the co-existence issue caused by the current combination of transceivers 210. For instance, for a first co-existence issue (e.g., at time T1) caused by a first combination of transceivers 210, such as the first transmitter 312 (e.g., WiFi transmitter) and the second receiver 324 (e.g., Bluetooth receiver), the processing system 201 (e.g., via the controller 230) may select from among the transmitters and the receivers, the first transmitter 312 for providing an input to the IC circuit 220 and the second receiver 324 for receiving an output of the IC circuit 220. Accordingly, interference caused by an aggressor transceiver (e.g., the first transmitter 312) upon a victim transceiver (e.g., the second receiver 324) can be reduced. In this case, if the coupling channel gain from the aggressor transceiver to the victim transceiver is −10 dB (e.g., due to separation of two antennas), then the IC circuit 220 may need to match this gain for successful IC. For a second co-existence issue (e.g., at time T2) caused by a second (different) combination of transceivers, such as the first transmitter 312 (e.g., WiFi transmitter) and the third receiver 334 (e.g., LTE band 7), the processing system 201 (e.g., via the controller 230) may select from among the transmitters and the receivers, the first transmitter 312 for providing an input to the IC circuit 220 and the third receiver 334 for receiving an output of the IC circuit 220. Accordingly, interference caused by an aggressor transceiver (e.g., the first transmitter 312) upon a victim transceiver (e.g., the third receiver 334) can be reduced. According to various embodiments, in such a case, if the coupling channel gain from the aggressor transceiver to the victim transceiver is −50 dB (e.g., due to separation two antennas and band pass filtering at the victim transceiver), then the IC circuit 220 may need to match this gain for successful IC.

In various embodiments, at block B510, the controller 230 is configured to detect a co-existence issue between at least two of the transceivers 210. The controller 230, for instance, may detect a co-existence issue when at least a transmitter (aggressor transmitter) and a receiver (victim receiver) of at least two transceivers 210 are active (e.g., transmitting/receiving) at once and the transmitter and the receiver are candidates for co-existence issues.

In some embodiments, the candidates may be provided in a look-up table or other database of known transceiver combinations that cause co-existence issues. Accordingly, when a combination of active transceivers is detected that appears in the table or database, a co-existence issue may be detected. In other embodiments, a sensor may be provided for sensing, measuring, or otherwise detecting interference, such as an intensity or magnitude of the interference, on a transceiver (e.g., receiver) or a symptom of interference, such as a reduced receiving signal or the like (e.g., reduced receiving rate, increased noise, etc.) by the transceiver. Accordingly, when interference or other symptom of interference is detected a co-existence issue may be detected.

At block B520, parameters of the detected co-existence issue may also be determined, for example, by the controller 230. For instance, the controller 230 may determine the parameters, such as the coupling channel gains, the frequency (e.g., f1), delay (e.g., d1), and/or the like of the aggressor transmitter. For example, if the first transmitter 312 is a WiFi transmitter, the first frequency f1 may be about 2.4 GHz and the first delay may be (but is not limited to) about 15 ns. For example, if the second receiver 324 is a Bluetooth receiver, the first frequency f1 may be about 2.4 GHz and the second delay may be about 15 ns. If the co-existence issue is between the first transmitter and the second receiver 324, the overall IC parameters are coupling channel gain −10 dB at 2.4 GHz and the overall delay is 30 ns.

At blocks B530 and B540, in response to the detection of the co-existence issue between the at least two transceivers, the controller 230 selects the transceivers causing the co-existence issue for processing by the IC circuit 220. For instance, in some embodiments, the transmitters 312, 322, 332, 342 may be coupled to an input multiplexer (MUX) 352 to receive corresponding signals 313, 323, 333, 343 from the transmitters 312, 322, 332, 342. The input multiplexer 352 is coupled to the IC circuit 220 to allow the input multiplexer 352 to select (e.g., as controlled by the controller 230) one the signals 313, 323, 333, 343 from one of the transmitters 312, 322, 332, 342 as input signal 356 to the IC circuit 220. The receivers 314, 324, 334, 344 may be coupled to an output multiplexer 354 to receive corresponding signals 315, 325, 335, 345 from the output multiplexer 354. The output multiplexer 354 is coupled to the IC circuit 220 to allow the output multiplexer 354 to select (e.g., as controlled by the controller 230) one of the receivers 314, 324, 334, 344 to receive an output signal 358 from the IC circuit 220.

For example, for a co-existence issue caused by a combination of transceivers, such as the first transmitter 312 (e.g., WiFi transmitter) and the third receiver 334 (e.g., LTE band 7), the controller 230 may select from among the transmitters, the first transmitter 312 for providing the input signal 356 to the IC circuit 220, and the controller 230 may select from among the receivers, the third receiver 334 for receiving the output signal 358 from the IC circuit 220. Likewise, in response to detecting a different co-existence issue caused by a different combination of the transceivers 210, the controller 230 may select the transceivers causing the different co-existence issue. In some embodiments, the controller 230 may activate the IC circuit 220, which may be deactivated or in a reduced power state, in response to detecting a co-existence issue.

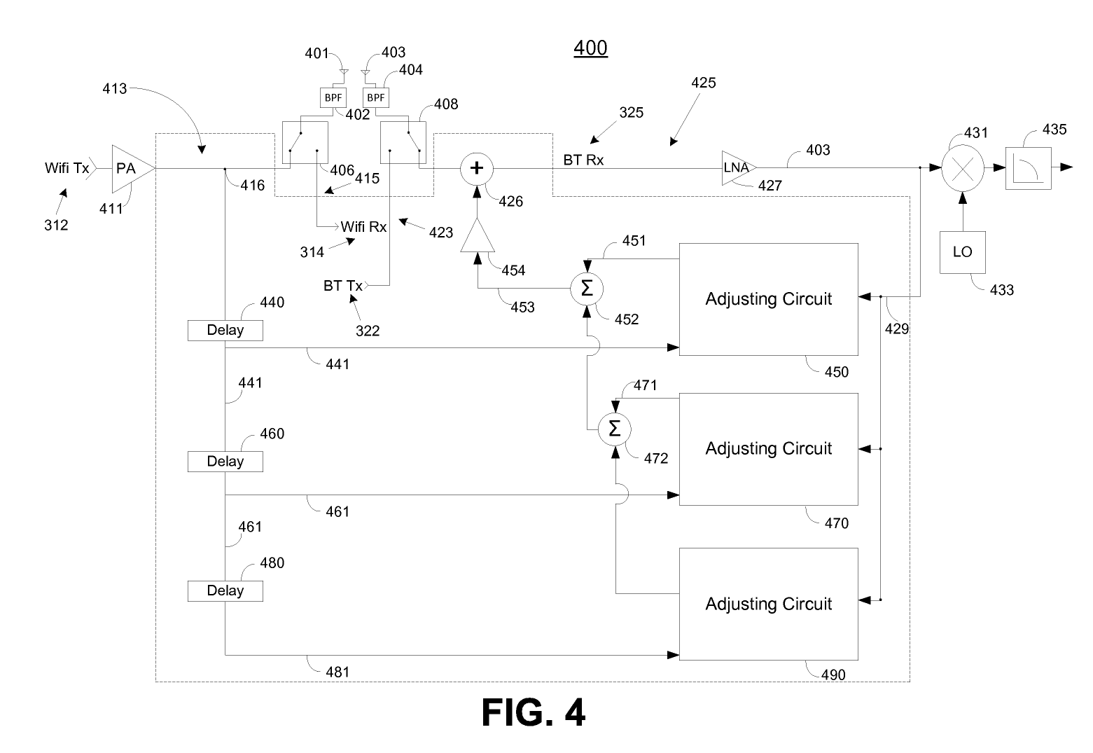

In various embodiments, at block B550, the controller 230 configures the IC circuit 220 based on the parameters of the co-existence issue (e.g., as determined at block B520). For instance, the IC circuit 220 includes an amplifier 454 and one or more delay elements (e.g., 440, 460, 460 in FIG. 4) that may be tuned to the coupling gain, the frequency, and the delay for the co-existence issue. For example, for a co-existence issue between WiFi and Bluetooth, the amplifier 454 is configured to provide the overall IC circuit gain of −10 dB and the delay elements may be tuned to 2.4 GHz and for a total delay of 30 ns. For instance, if three delay elements are employed, a delay of 10 ns each may be implemented by each delay element to provide a total delay of 30 ns.

Accordingly, at block B560, the IC circuit 220 may generate the output signal based on the input signal and the parameters to reduce the interference caused by the first transceiver upon the second transceiver.

The method B500 described in FIG. 5A above may be performed by various hardware and/or software component(s) and/or module(s) corresponding to the means-plus-function blocks B500′ illustrated in FIG. 5B. In other words, blocks B510 through B540 illustrated in FIG. 5A correspond to means-plus-function blocks B510′ through B540′ illustrated in FIG. 5B.

FIG. 4 is a functional block diagram of a communication system 400 employed with the device 102 (refer to FIGS. 1-2) and may implement the features and methods of such. With reference to FIGS. 1-5B, the communication system 400 includes the IC circuit 220 coupled to a transceiver (transmitter) selected by the controller 230 and a transceiver (receiver) selected by the controller 230, for instance, based on a co-existence issue between the transceivers (e.g., blocks B510-B540). For instance, in a case where a co-existence issue is detected between the first transmitter 312 of the first transceiver 212 and the second receiver 324 of the second transceiver 214, the IC circuit 220 is coupled to the first transmitter 312 and the second receiver 324. It should be noted that this combination is merely exemplary and that the controller 230 is configured to select from among other combinations (e.g., the first transmitter 312 with the third receiver 334 and/or the n-th receiver 344; the second transmitter 322 and the first receiver 314, the third receiver 334, and/or the n-th receiver 344; the third transmitter 332 and the first receiver 314, the second receiver 324, and/or the n-th receiver 344; the n-th transmitter 342 and the first receiver 314, the second receiver 324, and/or the third receiver 334) based on co-existence issues between such combinations.

In particular, the first transceiver 212 is electrically coupled to a first antenna 401. The first transmitter 312 of the first transceiver 212 transmits communication signals along a first transmit path 413 via a first band pass filter (BPF) 402 and the first antenna 401. The first receiver 314 of the first transceiver 212 receives communication signals along a first receive path 415 via the first antenna 401. The first transceiver 212 also includes a power amplifier 411 for amplifying signals transmitted by the first transmitter 312. The first transceiver 212 may also include a low-noise amplifier (LNA) (not shown) for amplifying signals received by the first receiver 314. In other embodiments, the first transceiver 212 and/or the second transceiver 214 (and/or components thereof and/or other transceivers) may share an antenna.

The first transceiver 212 may also include a T/R (transmit/receive) switch 406 that selectively connects either the first transmitter 312 or the first receiver 314 to the first antenna 401. That is, the T/R switch 406 connects the first transmitter 312 to the first antenna 401 when the first transceiver 212 is in a transmit mode of operation, while connecting the first receiver 314 to the first antenna 401 when the first transceiver 212 is in a receive mode of operation.

The second transceiver 214 includes the second transmitter 322, the second receiver 324, an LNA 427, and a T/R switch 408. The T/R switch 408 connects the second transmitter 322 (via a second transmit path 423) to a second BPF 404 and a second antenna 403 when the second transceiver 214 is in a transmit mode of operation, while connecting the second receiver 324 (via a second receive path 425) to the second antenna 403 when the second transceiver 214 is in a receive mode of operation. The second transceiver 214 may also include a power amplifier (not shown) for amplifying signals transmitted by the second transmitter 322.

The LNA 427 may be coupled to a mixer 431 along with a local oscillator (LO) generator 433. An output of the mixer 431 may be coupled to a baseband filter (BBF) 435. An output of the BBF 435 may be input to, for example (but not limited to), an analog to digital converter (ADC) (not shown).

The interference cancellation (IC) circuit 220 is configured to cancel (reduce) in-band and/or nearby out-of-band interference introduced onto the second receive path 425 by signals transmitted along the first transmit path 413 (by the first transmitter 312). In some embodiments, the input of the IC circuit 220 is coupled to the first transmit path 413 between the power amplifier 411 and the T/R switch 406 by way of a coupler 416. The coupler 416 obtains samples of signals transmitted by the first transmitter 312 and provides the samples to the IC circuit 220. Accordingly, the coupler 416 can obtain a sample or a representation of the interference or of the aggressor signal transmitted by the first transmitter 312, which produces, induces, generates, or otherwise causes the interference. In certain embodiments, the coupler 416 provides a direct connection to the first transmit path 413. Alternatively, a capacitor, resistor, antenna, or other device could be used in place of or in addition to the coupler 416 to obtain samples of the signals transmitted by the first transmit path 413. In various embodiments, the IC circuit 220 is configured by the controller 230 based on the parameters (e.g., frequency, delay, etc.) of the detected co-existence issue (e.g., block B550).

The IC circuit 220 adjusts the amplitude, phase, and/or delay of the sampled signals to produce an interference compensation signal that, when applied (e.g., via combiner or coupler 426) to the second receive path 425 of the second receiver 324, reduces, suppresses, or cancels the amplitude of in-band and/or nearby out-of-band interference and/or noise introduced onto the second receive path 425 by signals transmitted along the first transmit path 413. In particular embodiments, the IC circuit 220 adjusts the amplitude, phase, and/or delay of the sampled signals based on settings received from another device, such as the controller 230.

In some embodiments, an attenuator (not shown) may be positioned between the coupler 416 and the IC circuit 220 based on linearity considerations of the IC circuit 220. The attenuator can reduce the power level of a signal sampled from the first transmit path 413 to a power level appropriate for the IC circuit 220. In some embodiments, the coupler 416 has a low coupling coefficient. In some embodiments, signals transmitted by the first transmitter 312 are sampled at the input of the power amplifier 411 or at a point further upstream from the input of the power amplifier 411 (e.g., a pre-driver input) or other suitable location.

In some embodiments, the IC circuit 220 comprises a three-tap least-mean square (LMS) filter. It should be noted that in other embodiments, an LMS filter having any number of taps may also be implemented.

A first tap includes a delay element 440 and adjusting circuit 450. The delay element 440 receives, from the coupler 416, the sample of signals transmitted by the first transmitter 312 along the first transmit path 413. The delay element 440 forwards a delayed signal 441 after a first delay to the adjusting circuit 450 and a second tap.

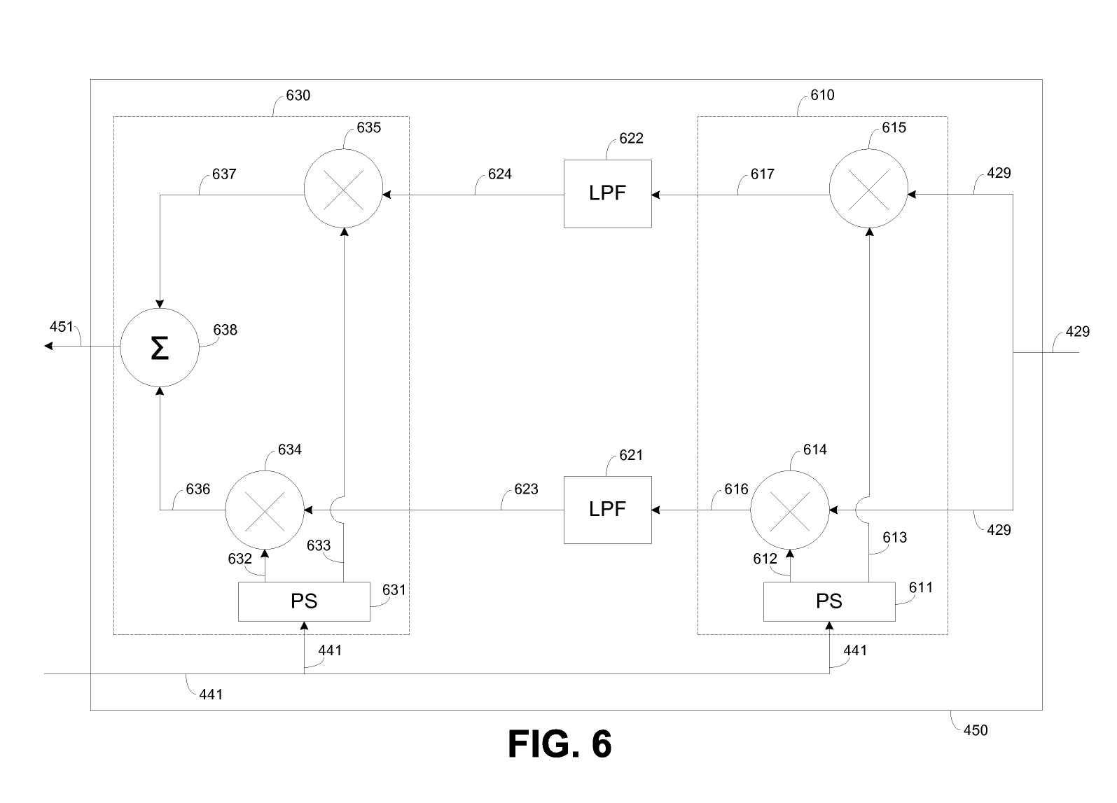

The adjusting circuit 450 receives the delayed signal 441 and a sample of a signal 429 transmitted along the second receive path 425 (e.g., sampled at the LNA 427) for processing thereby. FIG. 6 illustrates a non-limiting example of the adjusting circuit 450. With reference to FIGS. 1-6, the adjusting circuit include a first analog mixer 610 (a vector modulator) and a second analog mixer 630 (a vector demodulator). The first analog mixer includes a phase shifter 611 and multipliers 614, 615. The second analog mixer 630 include a phase shifter 631, multipliers 634, 635, and adder 641.

The delayed signal 441 is received by the phase shifter 611 of the first analog mixer 610. The phase shifter 611 shifts the delayed signal 441, for example, by 90 degrees as a first output 612 and forwards the delayed signal 441 without shifting as a second output 613. The first output 612 is received at the multiplier 614 along with the signal 429 to produce a resulting signal 616. The second output 613 is received at the multiplier 615 along with the signal 429 to produce a resulting signal 617. The resulting signals 616, 617 may be provided to respective low-pass filters 621, 622 to produce filtered signal 623 and filtered signal 624, respectively. The filtered signals 623, 624 are then passed to the second analog mixer 630.

The delayed signal 411 is also received by the phase shifter 631 of the second analog mixer 630. The phase shifter 631 shifts the delayed signal 441, for example, by 90 degrees as a first output 632 and forwards the delayed signal 441 without shifting as a second output 633. The first output 632 is received at the multiplier 634 along with the filtered signal 623 to produce a resulting signal 636. The second output 633 is received at the multiplier 635 along with the filtered signal 624 to produce a resulting signal 637. The resulting signals 636, 637 are provided to adder 641 to produce output 451.

The second tap includes a delay element 460 and adjusting circuit 470. The delay element 460 receives the delayed signal 441 from the delay element 440. The delay element 460 forwards a delayed signal 461 after a second delay to the adjusting circuit 470 and a third tap. The third tap includes a delay element 480 and adjusting circuit 490. The delay element 480 receives the delayed signal 461 from the delay element 460. The delay element 480 forwards a delayed signal 481 after a third delay to the adjusting circuit 490. For instance, if the first transmitter 312 is a WiFi transmitter transmitting at 2.4 GHz (interfering with a Bluetooth receiver), each delay element may be tuned to 2.4 GHz and to provide a total of 10 ns each for a total of 30 ns.

In various embodiments, the adjusting circuits 470 and 490 may be configured in a similar manner as the adjusting circuit 450. For instance, the adjusting circuit 470 may receive the signal 429 and the delayed signal 461 as input and produce output 471, and the adjusting circuit 490 may receive the signal 429 and the delayed signal 481 as input and product output 491.

The second tap may include an adder 472 for combining the output 471 of the adjusting circuit 470 of the second tap and the output 491 of the adjusting circuit 490 to produce combined output 473. The first tap may include an adder 452 for combining the combined output 473 of the adder 472 and the output 451 of the adjusting circuit 450 to provide a resulting combined signal 453. The resulting combined signal 453 may be applied, via the combiner or coupler 426 (after a proper amplification by the amplifier 454), to the second receive path 425. Accordingly, the resulting combined signal 453 is applied to the second receive path 425 of the second receiver 32 to reduce interference on the second receive path 425 by signals transmitted by the first transmitter 312.

In some embodiments, a co-existence issue may exist or be detected between more than two transceivers. For example, a co-existence issue may be detected when the first transceiver and the second transceiver causes interference with the third transceiver. In such embodiments, for instance, a signal from the first transceiver may be used by the IC circuit 220 to generate a first output signal, and a signal from the second transceiver may be used by a second IC circuit (not shown) to generate a second output signal. The third transceiver may receive the first output signal and the second output signal (separately or together) to reduce interference caused by the first transceiver and the second transceiver on the third transceiver. As another example, a co-existence issue may be detected when the first transceiver causes interference on the second transceiver and the third transceiver. In such embodiments, for instance, the second transceiver and the third transceiver may each receive the output signal generated by the (first) IC circuit 220 and the second IC circuit based on the input signal from the first transceiver to reduce interference caused by the first transceiver on the second transceiver and the third transceiver.

In some embodiments, the processing system 201 may selectively ignore or otherwise not manage a particular co-existence issue (e.g., via the IC circuit 220 and/or the controller 230) under certain circumstances. For example, the processing system 201 may selectively ignore or otherwise not manage the particular co-existence issue if the processing system 201 (e.g., the controller 230) determines that the particular co-existence issue is being managed by a different method and/or system. If the co-existence issue is managed by a baseband IC circuitry, the processing system 201 may not manage the issue with an analog IC circuitry. As another example, the processing system 201 may selectively ignore or otherwise not manage the particular co-existence issue if the processing system 201 (e.g., the controller 230) determines that the particular co-existence issue is below a specified threshold. For instance, the particular co-existence issue may be ignored if the issue causes light interference (e.g., a few decibels). That is, the co-existence issue may be ignored (or otherwise unmanaged) if an intensity of the interference is below a predetermined threshold. For example, if the interference is less than 10 dB above a sensitivity level of the receiver, the co-existence issue may be ignored.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of performing interference cancellation in a communication device having a plurality of transceivers, the method comprising:
detecting a co-existence issue between a first transceiver and a second transceiver of the plurality of transceivers;
determining parameters of the co-existence issue;
selecting the first transceiver for providing an input signal to an interference cancellation (IC) circuit;
selecting the second transceiver for receiving an output signal from the IC circuit;
configuring the IC circuit based on the parameters of the co-existence issue; and
generating the output signal based on the input signal and the parameters to reduce interference caused by the first transceiver on the second transceiver.

2. The method of claim 1, wherein the first transceiver comprises a transmitter and the second transceiver comprises a receiver.

3. The method of claim 1, wherein the generating comprises:
applying the output signal to a signal received by the second transceiver.

4. The method of claim 1, wherein the output signal is generated by the IC circuit.

5. The method of claim 1, wherein the parameters of the co-existence issue include at least a coupling channel gain, a frequency, and a delay of signal transmitted by the first transceiver.

6. The method of claim 1, wherein the first transceiver and the second transceiver are selected based on the co-existence issue between the first transceiver and the second transceiver.

7. The method of claim 1, further comprising:
detecting a second co-existence issue between the first transceiver and a third transceiver of the plurality of transceivers;
determining parameters of the second co-existence issue;
selecting the first transceiver for providing the input signal to the IC circuit;
selecting the third transceiver for receiving the output signal from the IC circuit;
configuring the IC circuit based on the parameters of the second co-existence issue; and
generating the output signal based on the input signal and the parameters of the second co-existence issue to reduce interference caused by the first transceiver on the third transceiver.

8. The method of claim 1, further comprising:
detecting a second co-existence issue between a third transceiver and a fourth transceiver of the plurality of transceivers;
determining parameters of the second co-existence issue;
selecting the third transceiver for providing the input signal to the IC circuit;
selecting the fourth transceiver for receiving the output signal from the IC circuit;
configuring the IC circuit based on the parameters of the second co-existence issue; and
generating the output signal based on the input signal and the parameters of the second co-existence issue to reduce interference caused by the third transceiver on the fourth transceiver.

9. The method of claim 1, wherein the first transceiver transmits signals on a frequency within a first frequency band;
wherein the second transceiver receives signals at frequency within a second frequency band; and
wherein the first frequency band at least partially overlaps the second frequency band.

10. The method of claim 1,
wherein the first transceiver transmits signals on a frequency within a first frequency band;
wherein the second transceiver receives signals at frequency within a second frequency band; and
wherein the first frequency band is adjacent the second frequency band.

11. The method of claim 1,
wherein the first transceiver transmits signals at a frequency within a first frequency band;
wherein the second transceiver receives signals at frequency within a second frequency band; and
wherein the first frequency band includes a sub-harmonic frequency of the second frequency band.

12. The method of claim 1,
wherein the first transceiver transmits signals at a frequency within a first frequency band;
wherein the second transceiver receives signals at frequency within a second frequency band; and
wherein the first frequency band includes a harmonic frequency of the second frequency band.

13. The method of claim 1,
the first transceiver transmits signals on a frequency within a first frequency band;
the second transceiver receives signals at frequency within a second frequency band;
a third transceiver transmits signals at frequency within a third frequency band;
wherein an intermodulation product frequency band of the first and third frequency bands at least partially overlaps the second frequency band.

14. The method of claim 1, wherein the detecting comprises:
accessing a database of known transceiver combinations that cause co-existence issues;
wherein the database includes a combination between the first transceiver and the second transceiver.

15. The method of claim 1, further comprising:
detecting an intensity of the interference caused by the first transceiver on the second transceiver;
wherein the co-existence issue is not detected if the intensity is below a predetermined threshold.

16. The method of claim 1, wherein the IC circuit comprises a multi-tap least mean square (LMS) filter.

17. The method of claim 16, wherein the LMS filter comprises a three-tap LMS filter.

18. The method of claim 1, wherein the IC circuit comprises a single-tap LMS filter.

19. The method of claim 1, wherein at least one transceiver of the plurality of transceivers is configured to receive navigation signals.

20. An apparatus for reducing interference in a communication device having a plurality of transceivers, the apparatus comprising:
an interference cancellation (IC) circuit;
a processor coupled to the IC circuit, the processor configured for:
detecting a co-existence issue between a first transceiver and a second transceiver of the plurality of transceivers;
determining parameters of the co-existence issue;
selecting the first transceiver for providing an input signal to the IC circuit;
selecting the second transceiver for receiving an output signal from the IC circuit;
configuring the IC circuit based on the parameters of the co-existence issue; and
the IC circuit configured to generate the output signal based on the input signal and the parameters to reduce interference caused by the first transceiver on the second transceiver.

21. An apparatus for reducing interference in a communication device having a plurality of transceivers, the apparatus comprising:
means for detecting a co-existence issue between a first transceiver and a second transceiver of the plurality of transceivers;
means for determining parameters of the co-existence issue;
means for selecting the first transceiver for providing an input signal to an interference cancellation (IC) circuit;
means for selecting the second transceiver for receiving an output signal from the IC circuit;
means for configuring the IC circuit based on the parameters of the co-existence issue; and
means for generating the output signal based on the input signal and the parameters to reduce interference caused by the first transceiver on the second transceiver.

22. A computer program product for reducing interference in a communication device having a plurality of transceivers, the computer program product comprising:
a computer-readable storage medium comprising code for:
detecting a co-existence issue between a first transceiver and a second transceiver of the plurality of transceivers;
determining parameters of the co-existence issue;
selecting the first transceiver for providing an input signal to an interference cancellation (IC) circuit;
selecting the second transceiver for receiving an output signal from the IC circuit;
configuring the IC circuit based on the parameters of the co-existence issue; and
generating the output signal based on the input signal and the parameters to reduce interference caused by the first transceiver on the second transceiver.
